(19) United States
(12) Patent Application Publication
(10) Pub. No.: US 2022/0111541 A1
(43) Pub. Date: Apr. 14, 2022

(54) Utility Knife

(71) Applicant: Kaelea Brickman, Wheatland, WY (US)

(72) Inventor: Kaelea Brickman, Wheatland, WY (US)

(21) Appl. No.: 17/500,661

(22) Filed: Oct. 13, 2021

Related U.S. Application Data
(60) Provisional application No. 63/090,716, filed on Oct. 13, 2020.

(51) Int. Cl. B26B 5/00

(52) U.S. Cl. CPC B26B 5/00

(57) ABSTRACT

A utility knife is disclosed that is easy to use and provides safety measures to the user. The knife has a handle having a proximal end and a distal end and a manually movable blade contained within said handle. The movable blade pivots at a point between the proximal and distal ends of the knife handle and exposes the blade for use from the distal end away from the horizontal plane of the handle. After using the utility knife, the blade automatically retracts back into the handle preventing accidental injuries from the blade. The utility knife also can be fitted with a safety lanyard and a locking pin to secure the blade in the closed position when not using the knife or in the open position when changing the blade.

### FIELD OF THE INVENTION

The present invention relates to a utility knife that is easy to use and provides safety protection to the user.

The present utility knife contains a handle having a proximal end and a distal end and a manually movable blade contained within said handle. The movable blade pivots at a point between the proximal and distal ends of the knife handle and exposes the blade from the distal end. After use of the utility knife the blade automatically retracts back into the handle.

### BACKGROUND OF THE INVENTION

A utility knife is used for general or utility purposes. The utility knife was originally a fixed blade knife with a cutting edge suitable for general work such as cutting hides and cordage, scraping hides, butchering animals, performing surgery (scalpel), cleaning fish, crafts and other tasks. Today, the term “utility knife” also includes small folding or retractable-blade knives suited for use in the home and general workplaces especially in the agriculture and construction industries. Retractable-blade knives usually contain a blade within the handle of the knife that retract in the same plane as the handle outwards to use like a fixed blade handle knife.

Werner U.S. Pat. No. 9,872,701 discloses a retractable device that has a cylindrical shape with a blade hidden inside of it. The blade can be moved out of the cylinder for use and then when not in use be retracted back into the cylinder.

Haugen U.S. Pat. No. 5,330,492 discloses a scalpel that has a spring biased retractable sheath that covers the blade. When a button is pushed the sheath retracts exposing the blade and when the button is released the sheath automatically returns to cover the blade.

Gleason et al US Published Patent Application 2010/0229399 discloses a fingertip knife. The Gleason et al knife is a cutting tool knife that has a retractable blade that can be moved forward and backward with one finger tip.

McChesney U.S. Pat. No. 9,676,105 discloses a retractable knife that is a fancy switch blade that has a spring-loaded mechanism to move the blade in and out.

The blade moves in the same plane as the handle.

Many utility knives pose a danger of accidentally cutting the user or an assistant to the user when the knife has to be passed on to free up the hands of the user. This is particularly the case for fixed blade utility knives and utility knives that require 2 hands to hide or cover the blade. Additional injuries can happen when a utility knife is accidentally dropped when the blade is exposed.

The present invention provides a much safer utility knife while providing a replaceable blade and excellent cutting capabilities. The present utility knife protects the user from accidentally being cut when exposing the blade prior to use and after use because the blade automatically retracts when the pressure of exposing the blade is released.

### SUMMARY OF THE INVENTION

Briefly, in accordance with the present invention, a utility knife that is easy to use and provides safety measures to the user contains a handle having a proximal end and a distal end and a manually movable blade contained within said handle. The movable blade pivots at a point between the proximal and distal ends of the knife handle and exposes the blade for use from the distal end away from the horizontal plane of the handle. After using the utility knife, the blade automatically retracts back into the handle preventing accidental injuries from the blade.

Of particular interest is an agricultural utility knife with:
(i) a first side plate having a proximal end, a distal end, a top portion and a bottom portion;
(ii) a second side plate having a proximal end, a distal end, a top portion and a bottom portion and
(iii) a blade holder, sandwiched in between the first side plate and second side plate, said blade holder having a proximal end and a distal end wherein said distal end of the blade holder is capable of (a) securely holding a blade extending toward the distal end and (b) manually moving the blade down below the distal end of the first and second side plates and (c) automatically retracting the blade back into the blade holder's original position.

A unique feature of the present utility knife is that the blade secured to the blade holder is positioned to face up toward the top of the side plates. When manually placed into the use position by the user the blade would be facing up. After using the utility knife, the blade is automatically retracted back into the knife handle in between the side plates. For additional safety protection the utility knife can be fitted with a lanyard that can be secured around the wrist of the user and/or a locking pin that keeps the blade in the open (cutting) position to change the blade or in the closed position retracted into the knife handle to prevent accidental opening of the blade.

### BRIEF DESCRIPTION OF THE DRAWINGS

FIG. 1 shows side views of the present utility knife in a closed position and in the open position FIG. 1A.

FIG. 2 shows an exploded view of the present utility knife assembly.

### DETAILED DESCRIPTION OF THE INVENTION

In practicing the present invention, a safety utility knife is made that contains a handle having a proximal end, a distal end and a manually movable blade contained within said handle. The handle is comprised of two side plates and, sandwiched in between the side plates, a blade holder with a replaceable blade, a pommel spacer and a spring. The middle portion of the blade holder protrudes upward above the side plates which allows the user to manually expose the blade for use by pushing the protruding blade holder down with a thumb thereby exposing the blade for use. The pommel spacer and the blade holder have a spring slot that holds a spring. The spring causes the blade holder to retract back into the handle when the pressure exerted to expose the blade is released. The movable blade pivots at a point between the proximal and distal ends of the knife handle and exposes the blade downwards for use from the distal end away (at an angle) from the horizontal plane of the handle. The side plates and the blade holder are configured to allow the blade holder to be manually pressed down while gripping the knife handle. When the blade holder is pressed down with the thumb of the user, the blade rotates away from the plane of the handle exposing the blade for use. After using the utility knife, the blade automatically retracts back into the handle when the user releases the pressure on the blade holder thus preventing accidental injuries. A locking pin can also be used to lock the blade in the closed position to prevent accidental opening of the blade when not in use or to lock the blade in the open position to allow for the safe changing of the blade with a replacement blade. The present utility knife can be made out of any standard knife materials but it is preferred to be made of stainless steel. The blades used can also be made of any blade material. Preferably, the blade is made of surgical steel especially a #60 scalpel blade. When a scalpel blade is used the present utility knife is useful for many agricultural uses including castrating calves.

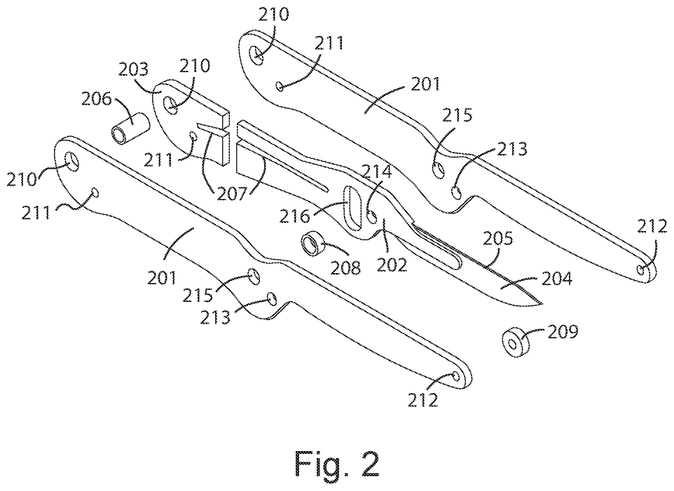

In other embodiments of the present invention a lanyard is secured to the knife to allow for better control of the knife. The lanyard is strung through the tubular rivet 206 described below and shown in FIG. 2. Additionally, a locking pin can be used to lock the blade in the open/cutting position when changing the blade or in the retracted/closed position providing further safety features.

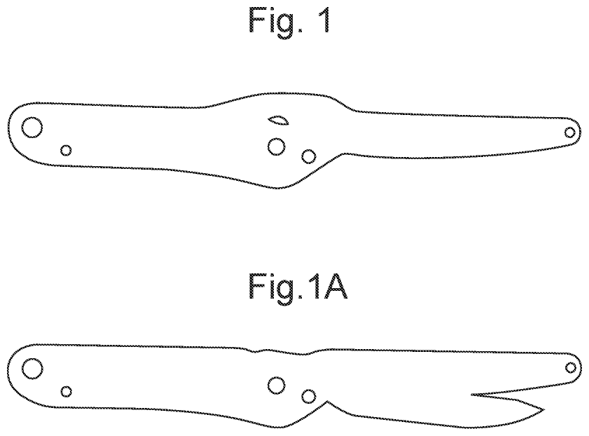

Referring to the drawings, FIG. 1 shows the present utility knife in the closed position and FIG. 1A shows the present utility knife in the open/cutting position.

FIG. 2 is an exploded view of the present knife. Two side plates 201 form the outside of the utility knife with a pommel spacer 203 and a blade holder 202 sandwiched or contained in between side plates 201. The side plates 201 and the pommel spacer 203 are secured together with pommel tubular rivet 206 inserted through corresponding apertures or holes 210 present in both side plates and the pommel spacer and with solid rivets (not shown) through corresponding apertures or holes 211 present in both side plates and the pommel spacer. The tip spacer 209 connects the distal end of the side plates 201 with a solid rivet (not shown). Blade holder 202 is secured to the side plates 201 with a bushing 208 and a barrel nut/Chicago screw (not shown) where the bushing resides in the rectangular aperture 216 in the blade holder. The nut/Chicago screw is inserted into aperture 215 from either side plate 201 through rectangular aperture 216 and bushing 208 to the opposite aperture 215 whereby the blade holder 202 is securely fastened to both side plate 201. This allows the blade holder to rotate when the top of the blade holder is pushed down by the user to expose the blade for use. A flat spring (not shown) is inserted into the spring slot 207 which forces the blade holder 202 to retract into the knife handle when the pressure exerted on the blade holder 202 is released by the user. Holes/apertures 213 in both side plates receive a locking pin (not shown) that secures the blade holder in the closed position. When in the closed position when the blade is not in use, the locking pin will be positioned below the blade holder 202 holding it in place within the handle (See FIG. 1). Holes/apertures 213 in both side plates and aperture/hole 214 in the blade holder 202 receive the locking pin (not shown) that secures the blade holder in the open position as desired by the user, for example when switching the blade

When in the open position when a blade is being replaced, the locking pin will be positioned through apertures 213 (side plates) and aperture 214 of blade holder 202 by lining up apertures 213 with 214. This will lock the blade in the open position and allow the safe replacement of the blade. The use of the locking pin is a valuable safety measure for when the blade is not being used and when the blade is being replaced.

The present invention may be embodied in other specific forms without departing from its spirit or essential characteristics. The described embodiments are to be considered in all respects only as illustrative and not restrictive. The scope of the present invention is, therefore, indicated by the appended claims rather than by the foregoing description. All changes which come within the meaning and range of equivalency of the claims are to be embraced within their scope.

The present application claims priority under 35 U.S.C. 119(e) to U.S. Provisional Application No. 63/090,716, filed on 13 Oct. 2020, the disclosure of which is incorporated herein by reference in its entirety.

I claim:

1. An article of manufacture comprising:
a. a knife handle having a proximal end and a distal end,
b. a manually movable blade contained within said handle wherein the movable blade pivots at a point between said proximal and distal ends of the knife handle and exposes the blade from the distal end.

2. The article of manufacture of claim 1 wherein the blade automatically retracts into the handle after use.

3. The article of manufacture of claim 2 further comprising a lanyard attached to the proximal end of the handle.

4. The article of manufacture of claim 2 further comprising a locking pin to lock the blade in the closed position to prevent accidental opening of the blade when not in use or to lock the blade in the open position to allow for the safe changing of the blade with a replacement blade.

5. An agricultural utility knife comprising:
a. a first side plate having a proximal end, a distal end, a top portion and a bottom portion,
b. a second side plate having a proximal end, a distal end, a top portion and a bottom portion,
c. a blade holder, sandwiched in between the first and second side plates, having a proximal end and a distal end wherein said distal end of the blade holder is capable of (i) securely holding a blade extending toward the distal end and (ii) manually moving down below the distal ends of the first and second side plates.

6. The agricultural utility knife of claim 5 further comprising a blade secured to the blade holder.

7. The agricultural utility knife of claim 5 wherein the blade automatically retracts into its original position in the blade holder.

8. The agricultural utility knife of claim 7 further comprising a lanyard attached to the proximal end of the side plates.

9. The article of manufacture of claim 7 further comprising a locking pin to lock the blade in the closed position to prevent accidental opening of the blade when not in use or to lock the blade in the open position to allow for the safe changing of the blade with a replacement blade.
